(19) United States
(12) Patent Application Publication
(10) Pub. No.: US 2010/0287188 A1
(43) Pub. Date: Nov. 11, 2010

(54) Method and system for publishing a document, method and system for verifying a citation, and method and system for managing a project

(76) Inventor: Samir Kakar, Centreville, VA (US)

Correspondence Address: HARNESS, DICKEY & PIERCE, P.L.C., P.O. BOX 8910, RESTON, VA, 20195, US

(21) Appl. No.: 12/662,705

(22) Filed: Apr. 29, 2010

Related U.S. Application Data
(60) Provisional application No. 61/213,069, filed on May 4, 2009.

(51) Int. Cl. G06F 17/00; G06F 17/30; G06F 3/048

(52) U.S. Cl. 707/769; 715/234; 715/764; 707/E17.014

(57) ABSTRACT

A system for publishing a document in a selected format may include a user interface configured to provide a plurality of presentation features to a user, a schema selection module configured to receive a schema for generating markup language content, wherein the schema includes a plurality of elements, a schema mapping module configured to map the plurality of presentation features to the plurality of elements, wherein a presentation feature maps to an element, a conversion module configured to generate tags for marking the markup language content based on the mapping, a document preparation system configured to receive input content from a user via an input module, a content generation module configured to generate markup language content from the input content using the generated tags and the presentation features, and a publication engine configured to generate the document in the selected format from the generated markup language content.

### CROSS-REFERENCE TO RELATED APPLICATIONS

This application claims the benefit of U.S. Provisional Patent Application No. 61/213,069, filed on May 4, 2009, the entire contents of which are incorporated herein by reference.

### FIELD

The present disclosure relates to a publishing tool that can publish content in various formats.

### BACKGROUND

Currently, most publishing tasks are performed on conventional document preparation systems, e.g. a word processor. For instance, an author will write chapters of a book and send the chapters to an editor as a single file or as a collection of files. Typically, the author will send each file via email or save a copy of the file to a file system accessible to the parties involved. In the former case, it is difficult to restrict the editor's ability to substantively alter the document, as complete control of the document is relinquished to the editor. In the latter delivery method, the chances of an editor writing over a current copy of a draft are increased. Also, neither delivery method allows for an efficient way for the publisher to assign and manage the tasks of the author or authors and the editors. Thus, there is a need to provide a word processing tool that allows for a publisher to manage the workflow of a document and that allows for all parties involved to have the proper amount of access to the document.

Furthermore, as the publishing industry quickly changes, there has been a growing trend to publish in various formats including hard-copy, on-line formats, and in ePub formats. Moreover, the interpretation of ePub standards may vary from device to device and continue to change. Thus, it is advantageous for publishers to have documents, both completed and uncompleted, stored in a format that provides the publisher with the flexibility to publish the documents in various formats.

Moreover, authors of technical works draft documents that have citations, figures, and tables. As can be appreciated, the author may neglect to properly format and verify the citations, or may improperly label figures or tables or callouts thereto. The author also has the potential to format and style the document in any way that he or she may see fit, despite specific stylistic requirements of the publisher. These types of departures from publishers' protocols require the publishers to employ additional editors solely to check citation formats, citation content and to check agreement between figures, tables and the callouts thereto.

This section provides background information related to the present disclosure which is not necessarily prior art.

### SUMMARY

This section provides a general summary of the disclosure, and is not a comprehensive disclosure of its full scope or all of its features.

According to example embodiments, a system for publishing a document in a selected format (the publishing may be or may not be automatic) may include a user interface configured to provide a plurality of presentation features to a user, where a presentation feature defines a manner in which a portion of the document is formatted, a schema selection module configured to receive a schema for generating markup language content, wherein the schema includes a plurality of elements defined in accordance with a markup language and a schema mapping module configured to map the plurality of presentation features to the plurality of elements of the schema for the document (the mapping may or may not be automatic, for example, it may be accomplished through a service provider), wherein a presentation feature of the plurality of presentations features maps to an element of the plurality of elements, a conversion module configured to generate tags for marking the markup language content based on the mapping of the plurality of presentation features to the plurality of elements, a document preparation system configured to receive input content from a user via an input module, wherein the input content is formatted by the user using the presentation features, a content generation module configured to generate markup language content from the input content using the generated tags and the presentation features used to format the input content, wherein the markup language content conforms to the received schema, and/or a publication engine configured to generate the document in the selected format from the generated markup language content.

According to example embodiments, a method for automatically publishing a document in a selected format (the publishing may or may not be automatic) may include providing a plurality of presentation features, where a presentation feature defines a manner in which a portion of the document is formatted, receiving a schema for generating markup language content, wherein the schema includes a plurality of elements defined in accordance with a markup language, mapping the plurality of presentation features to the plurality of elements of the schema for the document (the mapping may or may not be automatic, for example, it may be accomplished through a service provider), wherein a presentation feature of the plurality of presentations features maps to an element of the plurality of elements, generating tags for marking the markup language content based on the mapping of the plurality of presentation features to the plurality of elements, receiving input content from a user via an input module, wherein the input content is formatted by the user using the presentation features, generating markup language content from the input content using the generated tags and the presentation features used to format the input content, wherein the markup language content conforms to the received schema, and/or generating the document in the selected format from the generated markup language content.

According to example embodiments, a system for verifying a citation may include a document preparation system configured to receive input content from a user and configured to display the received input content to the user, a citation generation module configured to receive a request from the user to insert a bibliographic citation in the input content and configured to insert a plurality of fields corresponding to the bibliographic citation into the input content, wherein each field of the plurality of fields is a different component of the bibliographic citation, and wherein the citation generation module receives information from the user to fill the plurality of fields, and/or a citation verification module configured to generate a query based on the information used to fill the plurality of fields and queries a third party database to determine whether a record exists that corresponds to the information used to fill the plurality of fields.

According to example embodiments, a method for verifying a citation may include receiving input content from a user, wherein the input content is associated with content displayed by a document preparation system, receiving a request from the user to insert a bibliographic citation in the input content, inserting a plurality of fields corresponding to the bibliographic citation into the input content, wherein each field of the plurality of fields is a different component of the bibliographic citation, receiving information from the user to fill the plurality of fields, generating a query based on the information used to fill the plurality of fields, and/or querying a third party database to determine whether a record exists that corresponds to the information used to fill the plurality of fields.

According to example embodiments, a system for managing a project completed on a document preparation system may include an input module configured to receive a request to create a project, identities of a plurality of contributors to the project, a plurality of roles for the plurality of contributors, and a timeline indicating an order in which the plurality of contributors contribute to the project, wherein a role indicates a scope of contribution to the project by a particular contributor, a workflow management module configured to create a file corresponding to the project and to grant permission to the plurality of contributors to access the file, wherein the permission granted to a particular contributor defines an amount of access the particular contributor has to the file, wherein the amount of access corresponds to the role of the particular contributor, and/or a document preparation system configured to provide access to the file by the particular contributor in accordance with a scope of the permission granted to the particular contributor and according to the timeline.

According to example embodiments, a method for managing a project completed on a document preparation system may include receiving a request to create the project, receiving identities of a plurality of contributors to the project, receiving a plurality of roles for the plurality of contributors, wherein a role indicates a scope of contribution to the project by a particular contributor, receiving a timeline indicating an order in which the plurality of contributors contribute to the project, creating a file corresponding to the project, granting permission to the plurality of contributors to access the file on the document preparation system, wherein the permission granted to the particular contributor defines an amount of access the particular contributor has to the file, and wherein the amount of access corresponds to the role of the particular contributor, and/or providing access, via the document preparation system, to the file by the particular contributor in accordance with a scope of the permission granted to the particular contributor and according to the timeline.

Further areas of applicability will become apparent from the description provided herein. The description and specific examples in this summary are intended for purposes of illustration only and are not intended to limit the scope of the present disclosure.

### DRAWINGS

FIG. 1 is a drawing depicting a distribution model for the publishing tool;

FIG. 2 is a drawing depicting a project, subparts of the project and the contributors thereto;

FIG. 3 is a drawing depicting various configurations of a project;

FIG. 4 is a drawing depicting an exemplary workflow timeline;

FIG. 5 is a drawing depicting an exemplary multi-tiered architecture of the publishing tool;

FIG. 6 is a drawing depicting exemplary components of the publishing tool;

FIG. 7 is a flow chart depicting an exemplary method that may be executed by the publishing tool;

FIG. 8 is a drawing depicting examples of schema mapping;

FIG. 9 is a drawing depicting an exemplary interface for the document preparation system of the publishing tool;

FIG. 10 is a drawing illustrating exemplary components of the content generation module;

FIG. 11 is a flow chart depicting an exemplary method that may be executed by the content generation module;

FIG. 12 is a drawing illustrating exemplary components of the publication module;

FIG. 13 is a flow chart depicting an exemplary method that may be executed by the content generation module;

FIG. 14 is a drawing illustrating exemplary components of the content revision module;

FIG. 15 is a flow chart depicting an exemplary method that may be executed by the citation verification module; and

FIG. 16 is a flow chart depicting an exemplary method that may be executed by the ePub publishing module.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

Example embodiments will now be described more fully with reference to the accompanying drawings.

Disclosed herein is a publishing tool that streamlines the publishing process. In one aspect of the disclosure, the publishing tool can allow an administrator of the publisher to define specific tasks and roles to various parties involved in the publication of a document, such as authors, copy editors and managing editors.

In another aspect, the publishing tool can be configured to publish a document in a plurality of formats. The publishing tool is configured to allow a publisher to select or define a schema for generating XML content. The authors and editors can work on a document as if they are working on a standard document preparation system. The publishing tool receives the input of the author, for example, and converts to intermediate content, e.g. XML content. The XML content is used by the publishing tool to publish in different formats.

Furthermore, in another aspect of the invention, the publishing tool can analyze portions of the content to ensure that the author and editors have adhered to certain stylistic formats and/or that the citations contained in the document are proper.

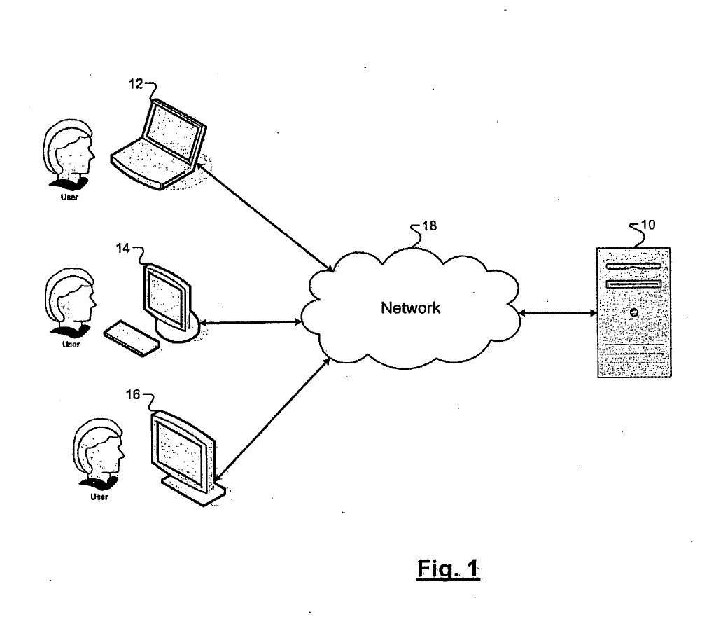

FIG. 1 illustrates an exemplary model for providing the publishing tool to publishers and related parties. The publishing tool is computer implemented and is embodied as computer executable instructions that are executed on one or more processors of an application server 10 of the publishing tool provider. End terminals 12, 14 and 16 are served by the publishing tool from the server 10 via a network 18. A user at the terminal 12 can access the publishing tool via a web browser. To access the publishing tool the user from the terminal 12 logs on to the publishing tool. The user is then given access to his or her documents and can perform various tasks, which are described below.

While reference is made to a client/server model, where the publishing tool is served from a “cloud,” it is appreciated that the publishing tool can be executed and delivered in various other ways, which are also within the scope of this disclosure. For instance, the publishing tool, or components thereof, may be stored on the computer memory of the terminals 12, 14, and 16 and executed on the processors of each terminal 12, 14 and 16. Also, as a web browser is contemplated for accessing the publishing tool, it is appreciated that other means of accessing the publishing tool are contemplated, such as a dedicated client. The content may be stored in a computer memory of the terminals or the servers of the publishing company.

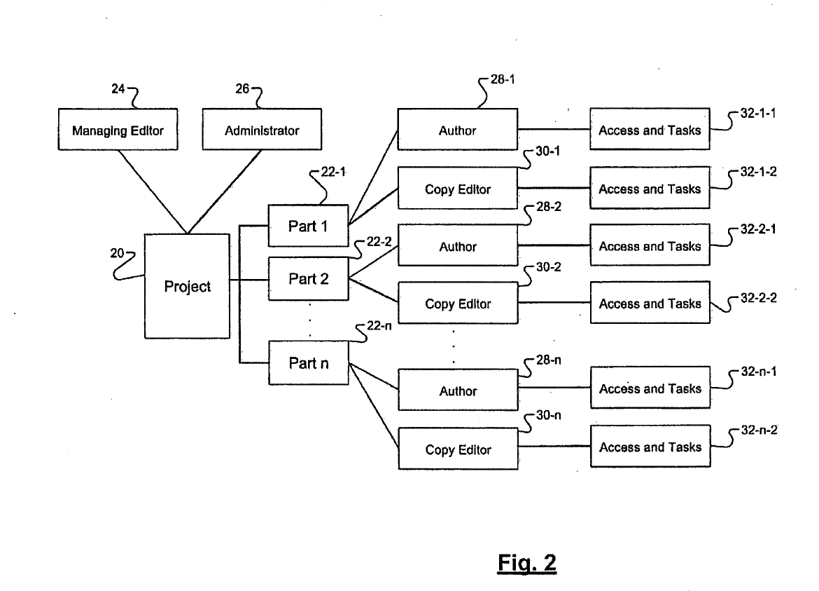

The publishing tool provides an environment for a publishing company to manage a project, such as the preparation and publication of a document, and for a user to prepare and/or edit the document. Furthermore, the publishing tool can be further configured to allow the publishing company, via an administrator for example, to assign various roles for a project. FIG. 2 illustrates an exemplary project 20 and the contributors thereto. A project can be a book, a publication, on-line content, a newspaper article, a technical paper, a journal article or any other type of authored work. The project can be broken down into a plurality of parts 22-1-22-n, e.g. chapters, articles, sections, etc.

Further, the publishing tool allows contributors to the project to have various roles. For example, a publishing company can designate an administrator 26 to set up the project 20. The administrator 26 can assign various roles for the project 20 in general or the parts 22-1-22-n thereof. As can be seen in this example, a managing editor 24 is assigned to manage the project 20, while each part is assigned an author 28-1-28-n and a copy editor 30-1-30-n. Furthermore, each role can be assigned tasks and given specific access to documents and permissions to work thereon. For instance, an author 28-1 may only be allowed to read and write to part 22-1. The author. 28-1, however, may be precluded from altering the formatting of part 22-1. A copy editor 28-1 may be allowed to read part 22-1 and may be allowed to insert comments or edits, but may be precluded from actually changing the content. The managing editor 24 may have read access to the entire project 20, but may be precluded from drafting content or editing content.

The foregoing is not intended to be limiting. It is envisioned that any number of roles may be defined by a publisher and any combination of access rights, permissions and tasks can be assigned to the various roles. Further, the roles may be predefined by the developer of the publishing tool, thereby allowing the administrator designated by the publishing company to assign roles using a menu of predefined roles.

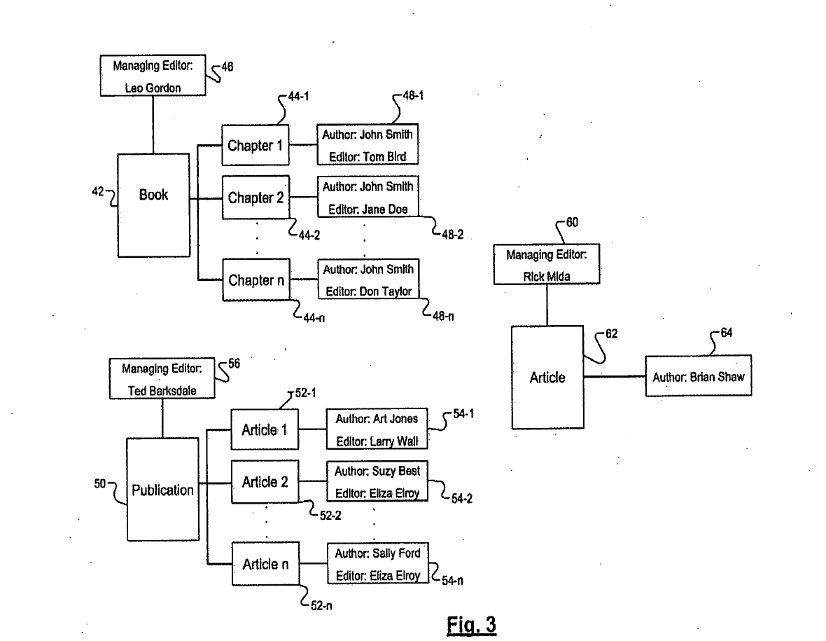

FIG. 3 illustrates examples of different types of projects. One such example is a book 42. The book 42 is broken up into many chapters 44-1-44-n. Shown in the example are the identities of the various contributors. As can be seen, the author of all the chapters is John Smith, but each chapter shown has a different copy editor. It is appreciated that the managing editor 46 can designate the various roles 48-1-48-n for each chapter 44-1-44-n.

It is appreciated that the managing editor 46 can design the project in various ways and can assign various roles. As can be seen, a publication 50 comprised of a plurality of articles 52-1-52-n may have different authors but overlapping copy editors 54-2 and 54-n. In another example, an article 60 may have no subparts, a managing editor 62, only one author 64 and no copy editor assigned thereto.

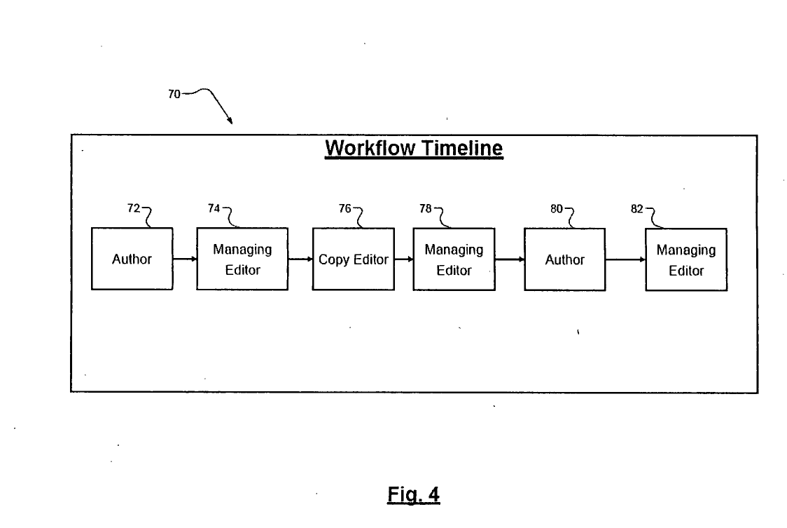

An administrator or a managing editor can also define a timeline for a project. FIG. 4 illustrates an example of a timeline 70. A timeline can be used to define the order in which the various contributors work on a project. For instance, in this example, the author first drafts the document at block 72, then when the first draft is complete a managing editor reviews the draft at block 73 before a copy editor provides comments and edits the document, which may be shown in a “track changes” mode, at block 76. The managing editor receives and reviews the copy editors contributions at block 78 before the document is returned to the author at block 80. The author can make the necessary revisions and then pass the final draft to the managing author at block 82. It is appreciated that a timeline may be defined in various ways and the foregoing is but one example of a defined timeline for a workflow. As will be described below, the documents in a project can be stored at a server accessible to the contributors so that at each block the current version of a draft is worked on. Further, older versions of a document may also be stored for later comparison.

The foregoing provides an exemplary administrative framework of the publishing tool relating to the creation and revision of the content of a project. After a project is completed, the publishing tool allows the publishing company to select various formats to publish in. For instance, the document can be published in an eBook format, on-line content, a PDF, and/or a hard copy proof format (which may be in viewed in PDF). Furthermore, the document can be stored in an XML format to facilitate later publishing in additional formats as they are developed.

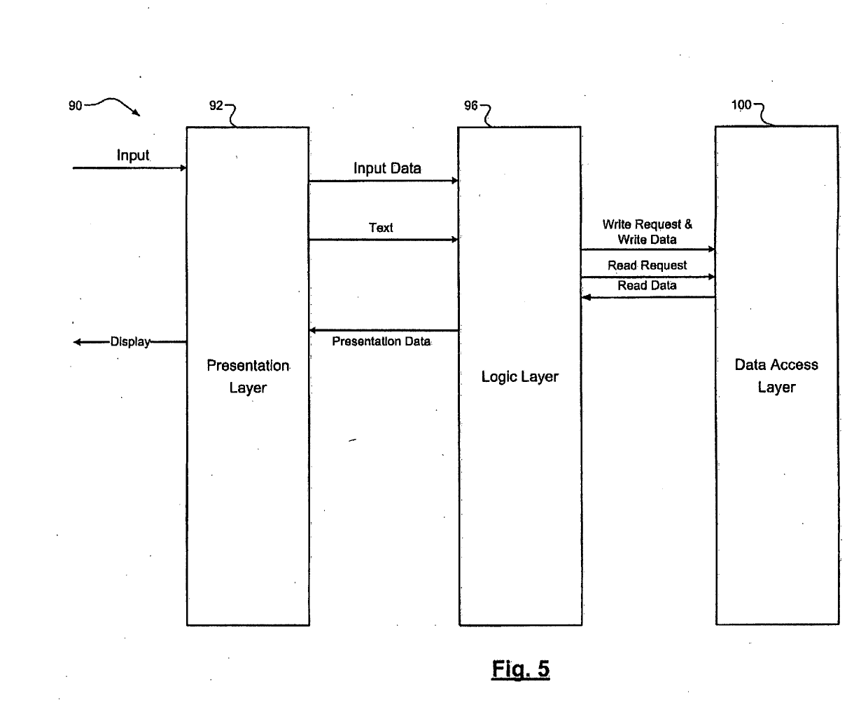

In the embodiments where the publishing tool is served from a server to client terminals, the publishing tool can be configured according to a multi-tiered architecture. FIG. 5 illustrates an exemplary architecture for the publishing tool. The architecture 90 is comprised of a presentation layer 92, a logic layer 96 and a data access layer 100.

The presentation layer 92 displays information to a user. The presentation layer 92 displays various user interfaces to one or more users. For instance, the presentation layer 92 can display a home screen where a user can select what functions they would like to perform on the publishing tool. The presentation layer 92 also displays a document preparation system so that a user can enter input, such as text or input commands received via a graphical user interface (GUI). The presentation layer 92 receives the input data and communicates the input data to the logic layer 96.

The logic layer 96 performs the data manipulation tasks of the publishing tool. The logic layer 96 receives data from the data access layer 100 and the presentation layer 92, and performs the tasks of the publishing tool. For instance, the logic layer 96 can be configured to control the workflow of a project, the various features of the document preparation system, and the components that perform the XML conversion and publishing. With respect to the workflow, the logic layer 96 receives input data from the user via the presentation layer 92 and creates rules defining the workflow, including identifying contributors to the project, their respective roles and their respective access rights. With respect to the document preparation system, the logic layer 96 receives the input content, either by text input of a user or by uploading a previously drafted document or XML content, and can convert the input content into XHTML, which is displayed by the presentation layer 92. The logic layer can be further configured to perform the various features in the document preparation system, such as spell checker, track changes, a math editor and the like. The logic layer 96 also performs the conversion to the various formats, including the intermediate XML content and the published formats. Beyond receiving the input data via the presentation layer 92 and generating XHTML content, the logic layer 96 also converts the input content into XML content, and publishes to the various publishing formats from the XML content. The converted content is communicated to the data access layer 100 for storage.

The data access layer 100 manages the databases of the publishing tool. The data access layer 100 receives read and write requests from the logic layer 96 and interacts with the databases accordingly. Possible databases that are controlled by the data access layer may include but are not limited to an XML database, a customer database, and a schema database.

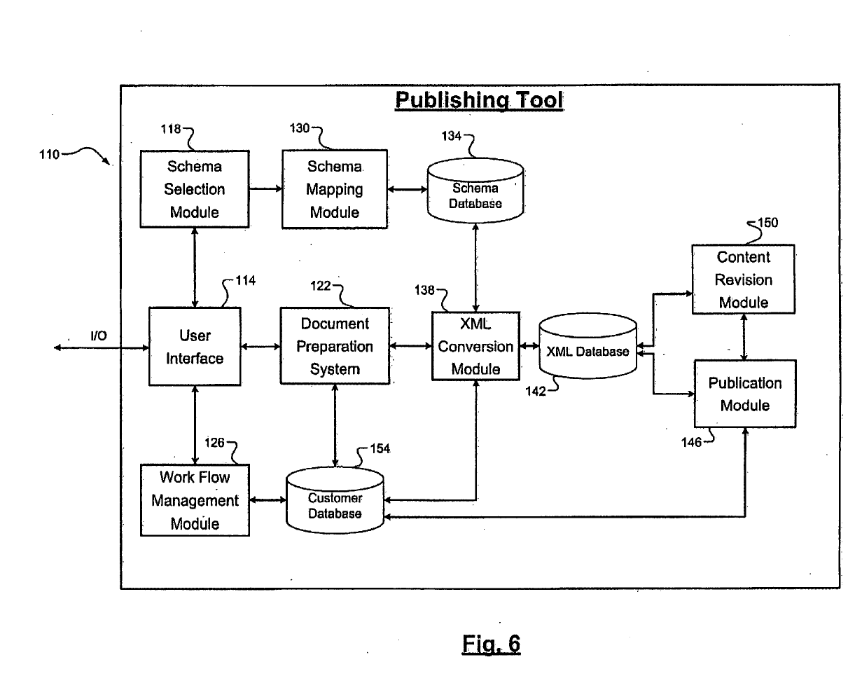

FIG. 6 illustrates exemplary components of the publishing tool 110. In this configuration, the publishing tool 110 may be comprised of a user interface 114 in communication with a schema selection module 118, a document preparation system 122 and a work flow management module 126.

The schema selection module 118 allows a user to select or define a schema used in the XML conversion. The schema selection module 118 is in communication with a schema mapping module 130, which is configured to map the presentation features of the document preparation system 122 to the elements of the schema. The schema mapping module 130 is in further communication with the schema database 134, which stores the schemas of various users.

The document preparation system 122 is configured to receive and display input content. As will be described, the document preparation system 122 allows a user to prepare, format, and/or edit content. The document preparation system 122 is in communication with the XML conversion module 138. The XML conversion module 138 converts the input content into markup language contents, which may include but are not limited to extensible markup language (XML) and extensible hypertext markup language (XHTML), using the selected schema stored in the schema database 134. The converted input content, e.g. the XML content, is stored in the XML database 142. The publication module 146 can publish the XML content into various formats, which may include but are not limited to electronic publication (ePub), portable document format (PDF), and hypertext markup language (HTML). The content revision module 150 receives the XML content and performs content analysis and revision thereon.

The workflow management module 126 is configured to receive workflow data from a user and to define workflow, roles, and permissions to other users of the publishing tool 110. The workflow, roles and permissions can be stored in a customer database 154. As described above, the workflow information may include the organization of a project and the roles and permissions of contributors to the project. Once a workflow is defined, the workflow for a project can be stored in a customer database 154. The customer database 154 may additionally store published content, e.g. published versions of a project.

The workflow management module 126 may receive a request to create a project. As discussed above, the project may have a plurality of parts. Thus, a subsequent request for a plurality of parts may also be received by the workflow management module 126. Upon receiving the request to begin a project, the workflow management module 126 will create a folder corresponding to the project as well as files corresponding to each part. When the administrator assigns roles to individual users, the workflow management module 126 will assign permission to the individual user to access a file. Furthermore, the workflow management module 126 will generate access rules for the individual user which define what type of access a user has to the file.

Taking the example of the book of FIG. 3, the workflow management module 126 may receive a request to start a new book 42 having N chapters. The workflow management module 126 can generate a folder for the book 42 and files for each chapter 44-1-44-n. Furthermore, the administrator creating the project may designate the authors for each chapter and the editors for each chapter. Upon receiving these designations, the workflow management module 126 may create permissions for accessing the file, such that author John Smith may have access to all N chapters but the content editor Tom Bird may have permission to chapter 1 only. Furthermore, if the administrator defines access rights for a role, e.g. authors can add new content but editors can only make comments or rearrange content, the workflow management module 126 may define specific access rights for each permitted user to a folder. These rules for accessing the created files may be stored in the customer database 154.

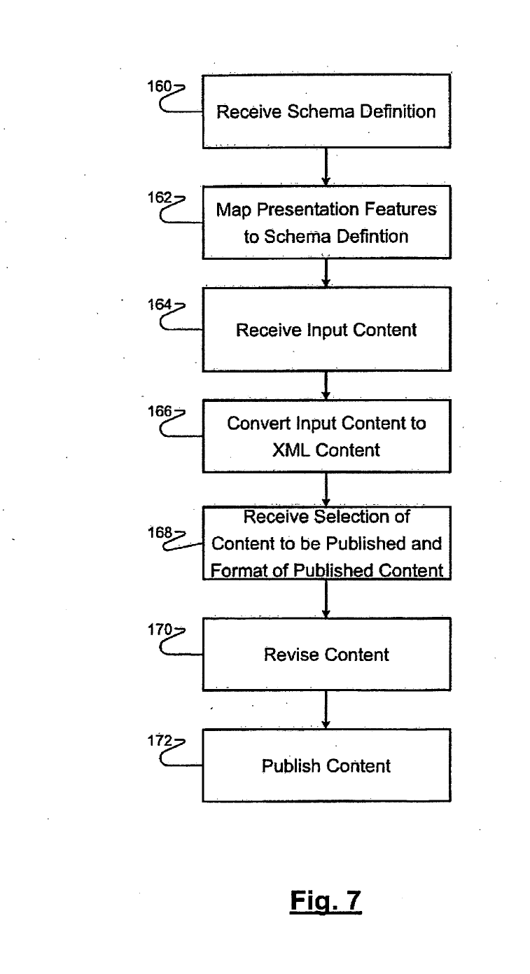

As discussed above, the publishing tool allows a user to create content on the document preparation system 122 of the publishing tool 110 and to publish in a plurality of different formats. FIG. 7 illustrates an exemplary method that may be executed by the various components of the publishing tool 110 to publish a document. As can be appreciated, individual publishers may have different in-house protocols for storing, displaying, and publishing content. Thus, publishers will employ different schemas for their XML content. Therefore, the publishing tool 110 is configured to receive a publisher's schema, as shown at step 160. This allows the publishing tool 110 to generate XML content corresponding to a publisher's preferred schema. A schema is a description for a type of XML document. The schema expresses the document type in terms of constraints of the content and structure of the document. The publishing tool 110 can be further configured to provide predefined schemas that the publisher can select from. Once a schema has been received or selected, the schema mapping module 130 maps the presentation features of the document preparation system to the schema, as is described below and shown at step 162.

The publishing tool 110 is further configured to receive input content of, an author or editor, as shown at step 164. As will be described, the publishing tool 110 includes a document preparation system 122 that allows a contributor to input text and objects into a document for later publication. The input content is then converted into XML content, or a variation thereof, by the XML conversion module 138, as shown at step 166. As will be appreciated, the XML content is an intermediate format that is used to prepare the input content to be published in different formats. Thus, the publishing tool 110 receives instructions from a publisher indicating one or more formats for publication and identifying what portions of the content to publish, as shown at step 168. Before publishing in the selected formats, the publishing tool 110 may revise the content by substantively analyzing citations contained in the document and/or analyzing the sequential ordering of objects contained in the content, as shown at step 170. Once the content has been revised, the publication module 146 publishes the content in the selected formats, as shown at step 172.

It is understood that the ordering of the foregoing method is not essential to the functionality of the publishing tool 110 and that not all of the steps are required. Further, it is appreciated that the foregoing is a computer-implemented method, such that the method is embodied as computer executable instructions stored on a computer readable medium and executable by a computer processor.

The exemplary components of the publishing tool 110 are now described in greater detail.

The user interface 114 (FIG. 6) is configured to display information to the user and to receive input therefrom. In the client/server model discussed above, the user interface 114 may present information to the user via a web browser installed on the user's terminal. The user interface 114 can be configured to receive input from a user via a mouse, keyboard, touchpad, and/or touch screen. Depending on the user input and the role of the user, the user interface 114 may display various screens to a user. For instance, if the user is an author, the user interface may present the user with a selection of chapters that he or she is authoring. Once the author selects a chapter, the user interface 114 may display the interface for the document preparation system 122. Similarly, if the user is an administrator, the administrator may be prompted with a schema selection screen or a work flow management screen. Once in a substantive screen, e.g. document preparation or schema selection, the user interface 114 will present the screen to the user. It is envisioned that any known technique in the art for displaying content to a user and receiving input therefrom may be implemented.

As mentioned, the user interface 114 is configured to communicate with the schema selection module 118. The schema selection module 118 allows a user, e.g. an administrator, to select or define a schema for generating XML content. It is envisioned that various schemas can be used such as a Document Type Definition (DTD) language, Document Definition Markup Language (DDML), Document Schema Definition Language (DSDL), or the like.

The user can either upload a schema, e.g. a DTD, or can select a predefined schema. The schema selection allows the publishing company to define the grammatical tags that are applied to the XML content. For example, a particular publisher may require that a title of a chapter be tagged as “TITLE,” whereas another publisher may prefer that a title of a chapter be tagged as “CHAPTER.” Thus, the schema selection module 118 allows the publisher to control the language defining the XML content.

In some embodiments, the schema selection module 118 allows a customer, e.g. the publisher, to define elements for a plurality of presentation features. A presentation feature may be thought of as a formatting option for presenting text or objects. For instance, presentations features may include, but are not limited to: a font type, a font size, margins, line spacing, and font effects such as boldface, italicized and/or underlined. Furthermore, the document preparation system 122 can be configured to limit an author's ability to design the format to a selection of presentation feature template from a plurality of presentation feature templates. A presentation feature template may be thought of as a set of predefined presentation features for a specific portion of the content. For instance, a presentation feature template for main body text may define the font as a 12 point Arial font, may define the margins as standard 1 inch margins, and may define the line spacing as double spacing. The schema selection module 118 allows the customer to define an element for each presentation feature format template. Thus, in the example provided above, the user can define an element called “BODY_TEXT” that corresponds to the main body text presentation feature template described above. The schema selection module 118 may further request that the user define elements for objects that the author is permitted to include in the content such as tables, images, spreadsheets, animations, and graphs.

A selected or uploaded schema is communicated to the schema mapping module 130, which generates a mapping of the presentation features of the document preparation system and the presentation feature templates to the selected schema. The schema mapping module 130 may also be configured to map the object types to the selected elements. Thus, for each presentation feature, presentation feature template and object type recognized by the document preparation system 122, the schema mapping module 130 generates a one-to-one mapping from each presentation feature, presentation feature template or object to the element selected by the publisher. The mappings can be used later to generate customized XML content as when a particular presentation feature or presentation feature template is used for a section of content, the schema mapping for the presentation feature is retrieved and the mapped-to element is used to tag the section of content.

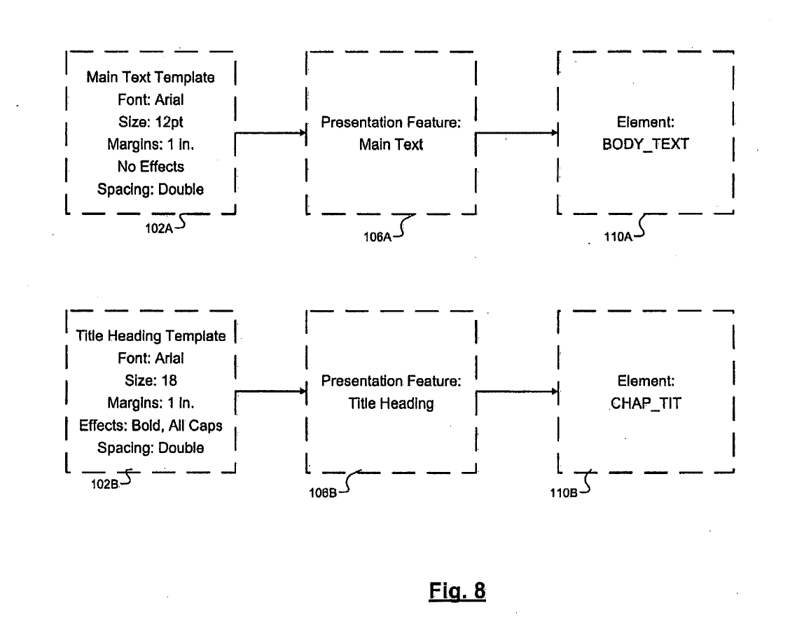

As mentioned, the schema mapping module 130 may be configured to map presentation feature templates to elements of the schema. FIG. 8 illustrates exemplary mappings of presentation feature templates to a schema. As can be seen, presentation feature templates 102A and 102B define a plurality of formatting options. For instance, the main text template 102A results in text displayed in a 12 point Arial font with standard 1 inch margins and double spacing. The presentation feature corresponding to the template in this example is known as “Main Text.” In this example, the publisher has designated a tag of “BODY_TEXT” to be applied to text formatted as main text. In this example, the schema mapping module 130 maps the presentation feature template Main Text 104A to the element BODY_TEXT 106A. Similarly, the presentation feature template “Title Heading” 104B has been mapped to CHAP_TIT 106B.

Once the various presentation features are mapped to the schema, the mapped schema is stored in the schema database 134. The mapped schema can be indexed by customer, e.g. an identifier of the publisher, by project, e.g. an identifier of the project, or by other identifiers. By storing the mapped schema of a publisher, the publisher can select a previously mapped schema from a previous project for a later project. Similarly, if the publisher opts to select a predefined schema and use default presentation features, a mapping of the schema may not need to be performed.

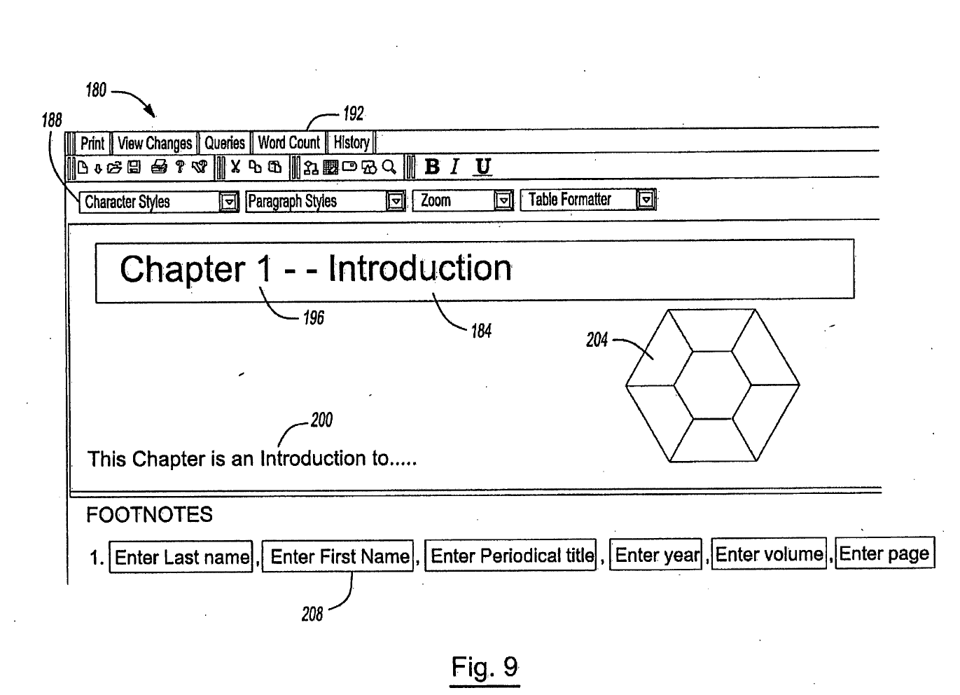

The document preparation system 122 is a component of the publishing tool 110 that is used to author and edit a document. FIG. 9 provides an exemplary screen shot that illustrates an example interface 180 of the document preparation system 122. The exemplary interface 180 merely provides context to descriptions of the document preparation system 122 and is not intended to be limiting. Similar to most document preparation systems, the interface 180 includes an editing window 184, which displays inputted text, images, tables, and other objects to a user. The interface 180 may further include a command field 192 for inputting commands such as print, view changes or view comments, and a presentation feature field 188 for selecting presentation features, such as heading style, superscript, bolding, and underlining, or presentation feature templates.

The user can select a presentation feature from the presentation feature field 188 and the content input by the user will be reflected accordingly in the editing window 184. For instance, at section 196, the user has entered a section heading entitled “CHAPTER 1-FOUNDATION CONCEPTS”. Prior to inputting this text, the author may have selected a presentation feature template corresponding to a chapter heading or an analogous designation. A selection of a presentation feature template provides a command to the document preparation system 122 to format the text in accordance with the publisher's predefined presentation features for the chapter heading. As previously discussed, the presentation features may include, amongst other features, a particular font type and size, margin size, background color, and/or text alignment.

Similarly, at section 200 the user has entered main body text, which may also be predefined by the publisher, such that the font type and size, the margins, the margins, text-alignment and line spacing are defined in advance by the publisher. The document preparation 122 system may include a formatting database (not shown), which includes the predefined presentation feature templates of the publisher. The formatting database may also include default presentation feature templates that are defined by the publishing tool provider.

In addition to the user entering text, the user may also select other presentation features. For instance, the user can format one or more characters as superscript, subscript, bold-faced, underlined, italicized, or strike-through. The user can also command the document preparation system to perform conversion of text to all capital letters or all lower case letters.

The document preparation system 122 may also provide a user with predefined templates for entering citations. In many technical or scholarly works of authorship, an author may be required to enter citations. Further, depending on various factors, the citation formats may vary. Thus, the publisher can define citation formats for a project. The author can then select to insert a particular citation, e.g. book, article, website, presentation, etc. A citation template will be presented to the user as a plurality of fields, in which the author enters the requested information. Section 208 illustrates an exemplary citation template. The citation can be presented according to the publishers requested format wherein the user is instructed to enter specific fields, such as an author's first and last name, a title, a volume number, etc. Furthermore, if the citation format needs to be changed, all of the citations can be changed by redefining the citation format, as the entered fields can be stored individually as XML content. As will be described below, the citation is converted into XML content as a citation and can later be substantively verified by cross-checking a database such as the Library of Congress.

The document preparation system 122 may be further configured to receive and display objects. The objects may include but are not limited to: images, tables, spreadsheets, and equations. Section 204 shows an exemplary image that has been inserted in the editing window 184. The document preparation system can allow a user to Create an object such as a table or spreadsheet, or allow the user to upload or import the object from various sources, which may include but are not limited to the user's terminal, a database of the publisher, on-line resources, or a database on the publishing tool.

As can be appreciated, a user enters content such as text via the user interface 180. As the user enters content, the inputted text is displayed by the interface in a format such as XHTML. The inputted content may also be communicated to the XML conversion module 138. The XML conversion module 138 receives the inputted content and generates XML content. The XML conversion module 138 may generate the XML content at predetermined intervals, in real-time, or after specific events, such as when the user selects to save the content.

In some embodiments, the document preparation system 122 maintains a buffer that stores the inputted content, along with any associated metadata. The inputted content may include but is not limited to: the actual content, e.g. text, that was entered and the presentation features relating thereto. The metadata may include but are not limited to: the identity of the user who is inputting the content, the time the content was entered, whether the new content is an edit or new text, and if an edit, the changes that were made. As the user inputs content, the content along with the associated metadata are stored in the content buffer, until the content and metadata are communicated to the XML conversion module 138.

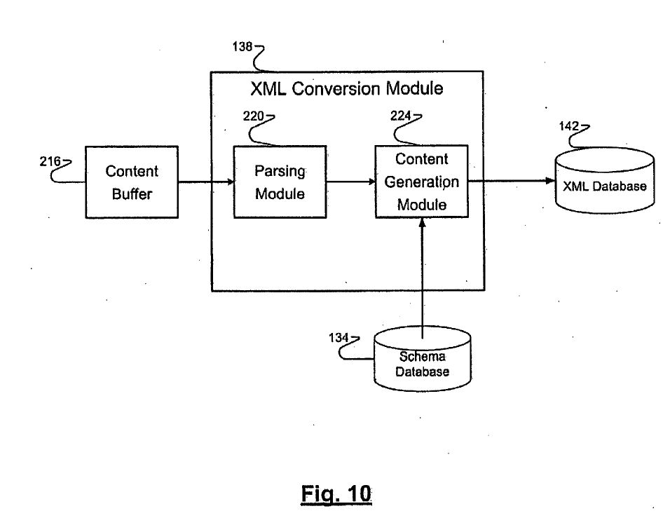

FIG. 10 illustrates an exemplary XML conversion module 138. The XML conversion module 138 may be comprised of a parsing module 220 and a content generation module 224. The parsing module 220 receives the input content from a content buffer 216 associated with the document preparation system 122 (FIG. 6) and parses the input content into sections grouped by identical presentation features. The parsed content is communicated to the content generation module 224, which in turn generates XML content from the parsed content using the mapped schema stored in the schema database 134.

The parsing module 220 parses the input content and can group the parsed content into portions having the same presentation features. As can be appreciated, the author of a document may format different sections using different presentation features. Thus, when the parsing module 220 receives the input content from the content buffer 216, the parsing module 220 may examine the content for strings of text having the same presentation features. Thus, the parsing module 220 may examine the input content character by character until the presentation features of the next character vary. Once this point in the input content is determined, the string of characters having the same presentation features is communicated to the content generation module. Similarly, if an object such as an image or spreadsheet is encountered, the preceding string is communicated to the content generation module 224. The parsing module 220 may continue to parse the input content in this manner.

The foregoing implementation of the parsing module 220 is one possible implementation and other implementations are contemplated. For instance, if the input content is represented in XHTML, the parsing module 220 may parse the XHTML content whereby a character by character examination of the content is not performed.

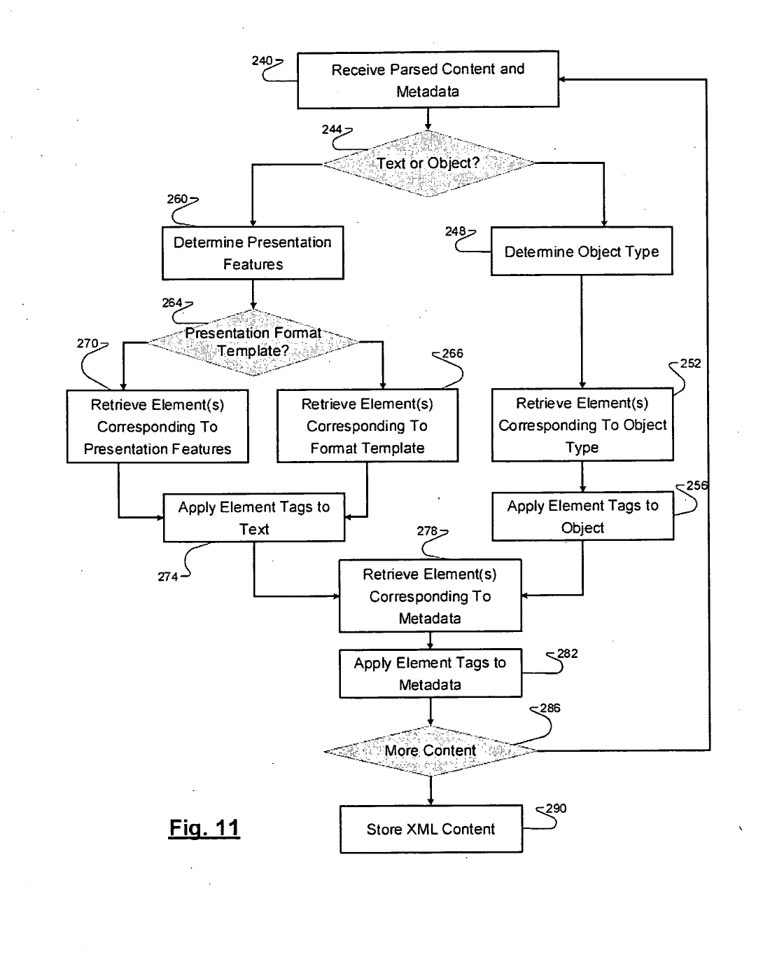

The content generation module 224 is configured to receive the parsed content from the parsing module 220 and to generate XML content corresponding thereto. FIG. 11 illustrates an exemplary method for generating the XML content.

The parsed content is content generation module 224 at step 240. The parsed content may include the actual inputted content, the corresponding presentation features, and the corresponding metadata. The parsed content may be text or may be an object. Once the parsed content is received, a determination is made as to the type of content, as shown at step 244.

If the content is an object, the type of object is determined as shown at step 248. For instance, the object may be an image, a table, a spreadsheet, an equation, a hot link, or the like. Depending on the type of object, the elements corresponding to the type of object are retrieved from the schema database 134, as shown at step 252. As can be appreciated, the schema database 134 will map the object types to the corresponding elements. After the element or elements corresponding to the object are retrieved, the content corresponding to the object is tagged using the retrieved element or elements, as shown at step 256.

If the content is text, the content generation module 224 determines the presentation features of the content, as shown at step 260. This may include determining the font type and size, the margins, the spacing, the alignment and other features of the text. The content generation module 224 may also determine whether a presentation feature template was used to format the input content, as shown at step 264. If the presentation features correspond to a presentation feature template, then the content generation module 224 retrieves the schema elements corresponding to the presentation feature template, as shown at step 266. If no particular format was used and the author manually defined the presentation features, the elements corresponding thereto are retrieved from the schema database 134, as shown at step 270. Once the elements are retrieved, the parsed text is tagged using the corresponding elements, as shown at step 274.

The content generation module 224 can be further configured to tag the metadata corresponding to the content. This may include the identity of the author or editor responsible for the content, the time that the content was added or removed, or any other additional data that the publishing tool maintains. The elements relating to the metadata are retrieved from the schema database, as shown by step 278, and applied to the metadata, as shown at step 282.

The content generation module 224 can repeat the foregoing to the extent additional parsed content remains. If the parsed content is exhausted, the content generation module 224 stores the generated content in the XML database 142, as shown at step 290.

It is appreciated that the foregoing is one possible method for generating XML content. The steps provided above are provided for reference and the ordering thereof is not the only possible ordering. Furthermore, it is appreciated that other means of generating the content may be implemented. The content generation module 224 can be embodied as computer readable instructions stored on a computer readable medium and can be executed by a processor associated with the computer readable medium.

Once XML content or the equivalent thereof is generated by the XML conversion module 138, the publication module 146 of the publishing tool 110 can publish the original content in various formats, which may include but are not limited to ePub, PDF, on-line content, a proof for a hard copy, amongst other formats. Furthermore, publication module 146 may receive revised content from the content revision module 150, which is configured to review and revise the content to be published.

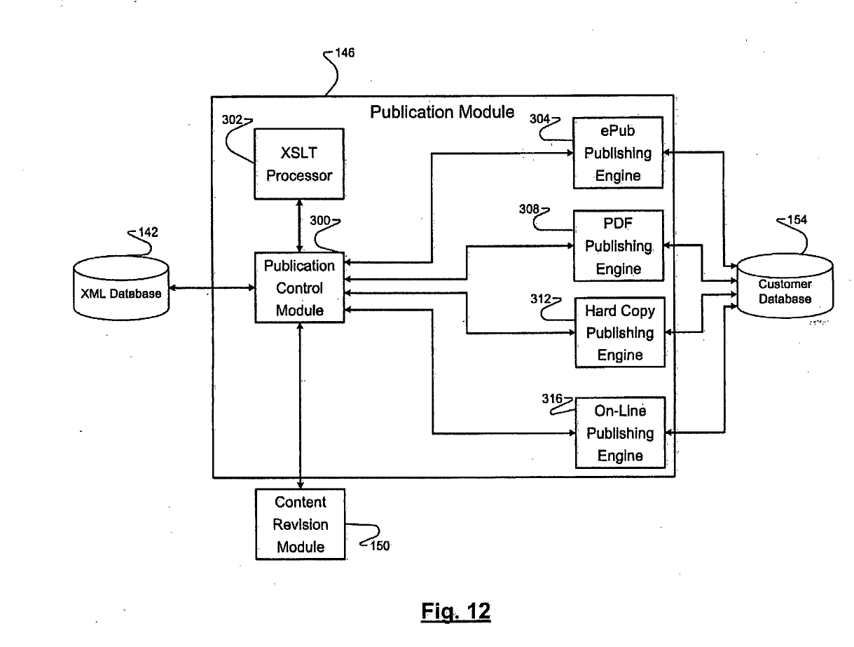

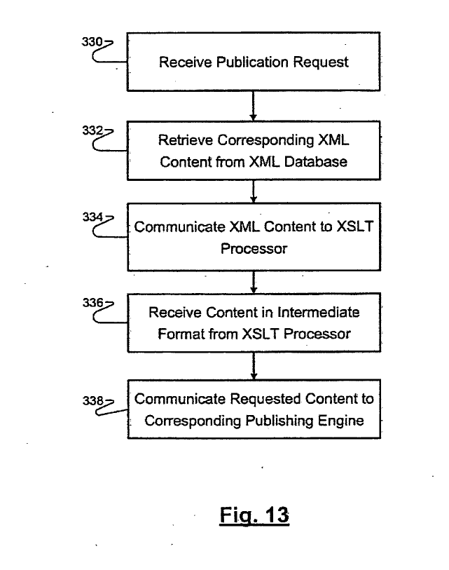

FIG. 12 illustrates exemplary components of the publication module 146. The publication module 146 may be comprised of a publication control module 300, an XSL Transformation (XSLT) processor 302, and a plurality of publishing engines 304, 308, 312 and 316. FIG. 13 shows an exemplary method that may be executed by the publication control module 300. The publication control module 300 receives a publishing request of a publisher, as shown at step 330. A publishing request can indicate the various formats that the publisher requested publication in as well as the identity of the contents to be published. For instance, a publisher may elect to have a book published to ePub and hard copy. The publisher may want to provide excerpts of a book on-line, however. The publisher may then also designate one of the chapters of the book to be published in an on-line format.

Upon receiving the publication request, the publication control module 300 will retrieve the content to be published from the XML database 142, as shown at step 332. The publication control module 300 will then communicate the content to be published to the XSLT 302, as shown at step 334, which processes the XML content into an intermediate format for later publishing, e.g. HTML or XHTML. The XSLT processor 302 may include a module to execute XSL files, such as Saxon and a file format converter, such as Ghostscript.

Upon receiving the intermediate content in the intermediate format, as shown at step 336, the publication control module 300 communicates the content to be published to the various publishing engines, as shown at step 338. Referring to the example above, the entire book will be communicated to the ePub publishing engine 304 and the hard copy publishing engine 312, while one chapter will be communicated to the online publishing engine 316.

As mentioned the publication module 146 may include a plurality of publishing engines. The publishing engines may include but are not limited to: an ePub publishing engine 304 which publishes content in an ePub format for viewing on an eBook device; a PDF publishing engine 308 that publishes content into a PDF format; an on-line publishing engine 316 which publishes content into an on-line format such as HTML; and a hard copy publishing engine 312 which publishes into a hard copy proof for later publication of a hard copy. It is appreciated that other publishing engines can also be included in the publication module 146.

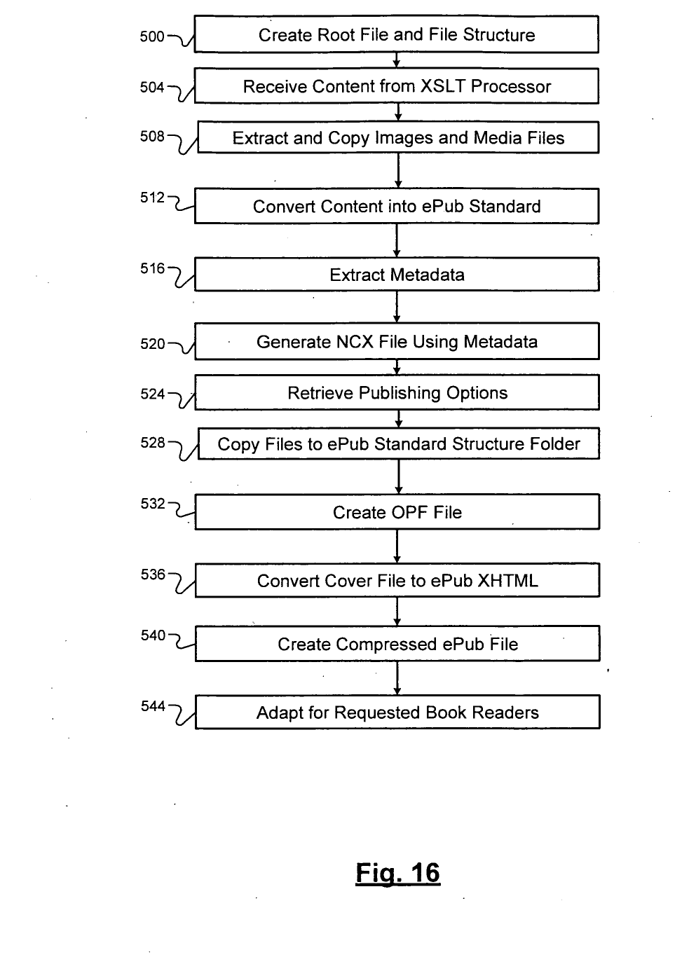

The ePub publishing engine 304 receives the intermediate content from the XSLT processor 302 and converts the intermediate content into an ePub format. FIG. 16 illustrates an exemplary method that may be executed by the ePub publishing engine 304. As can be appreciated, the ePub format requires a plurality of files to be loaded onto an ePub reader. Thus, the ePub publishing engine 304 creates a root folder, which for the ePub content to store the plurality of files, as shown at step 500. The root folder will contain a plurality of subfolders, which comprise the standard ePub file structure.

The ePub publishing engine 304 receives the intermediate content from XSLT engine 302 and extracts the images and media files from the XSLT content, as shown at steps 504 and 508. These files correspond to the text and objects contained in the document to be published. These files can be stored in an images subfolder the root folder. The ePub publishing engine 304 further converts the intermediate content, which may be in XHTML to the ePub standard XHTML, as shown at step 512.

As can be appreciated, the ePub format typically includes a navigation control for XML file (NCX file), which is a hierarchical table of contents. To create the NCX file, the ePub publishing engine 304 extracts the metadata from XHTML content, as shown at step 516. The metadata may include a list of chapters, an author's name, the date of creation, the publisher's name, etc. From the metadata the NCX file can be generated, as shown at step 520. The ePub publishing engine 304 can also retrieve the publishing options used to display the content, as shown at step 524. At step 528, the various ePub files are stored in the ePub root folder. It is appreciated that the standard root folder may include subfolders for fonts, metadata, images, and formatting options. Thus, the ePub publishing engine 304 may copy the font information to the font subfolder, a metadata XML file into the metadata folder, a cover file into the image folder, an audio-player file into the images file and a mimetype folder into the root folder. Also, a default cascade styling sheet (CCS) file may be copied into a CCS folder. The ePub publishing engine 304 also creates an OPF file, as shown at step 532. The OPF file stores the document's metadata, file manifest, and linear reading order.

Additionally, the ePub publishing engine 304 retrieves the cover file and converts the cover file to ePub XHTML, as shown at step 536. The converted cover file can be stored in the images sub folder, as discussed above.

Once all of the files are copied into the ePub standard structure folder, the ePub publishing engine 304 compresses the ePub file, as shown at step 540. This can be performed using compression algorithms known in the art.

It is further envisioned that once the content has been converted to the ePub format, the ePub content may be further converted on differing devices, as shown at step 544. For instance a 3^{rd} party tool called Calibre may be used to convert the ePub file to a .Irf file for the Sony® reader or a .MOBI file for the Amazon Kindle®. It is appreciated that the ePub file may also be converted so that it is capable of being displayed on a laptop computer, a tablet computers such as an iPad®, or mobile equipment.

As can be appreciated, the order of the steps described above is not mandatory and some of the steps may be combined into a single step. Furthermore, it is appreciated that the standards for ePub may change and the foregoing may be adapted to accommodate newly adopted standards.

The PDF publishing engine 308 publishes the content to a portable document format (PDF). The PDF publishing engine receives the intermediate content from the XSLT processor 302 and generates a PDF therefrom. The PDF publishing engine 308 may incorporate third party tools such as a LaTeX engine, CSS3, or InDesign. These tools receive the intermediate content generated by the XSLT processor 302 and generate a PDF therefrom.

The hard copy publishing engine 312 is configured to generate a hard copy proof of the published content. The hard copy publishing engine 312 may receive publisher instructions, such as formatting options for the hard copy proof. The hard copy publishing engine 312 then generates a PDF in a manner similar to the PDF publishing engine 308 using the formatting options or other publisher instructions.

The online publishing engine 316 allows the publisher to directly publish content online. In order to publish online, the online publishing engine 316 may require information from the publisher such as a server name, a database name, a table name, a database type, an FTP address, a user, and/or a host. The intermediate content received from the XSLT processor 302 is converted into HTML and the HTML content is then integrated into the content management system (CMS) of the publisher. Once integrated into the CMS of the publisher, the content is available to view online.

It is further envisioned that the publication module 146 can be further configured to facilitate the publication of mathematical equations, expressions or symbols that are not recognized by an eBook format or another selected format. As a publishing engine is converting the XML, or intermediate content from the XSLT processor, a publishing engine may encounter an unrecognized symbol. In order to display the unrecognized symbol, the publishing engine will create an image of the unrecognized symbol. This can be achieved, for example, by creating a .gif, a .jpg, a .bmp image file of the unrecognized symbol. The image of the unrecognized symbol is tagged as an image in the XML content. The unrecognized symbol is removed from the content and replaced with the image of the unrecognized symbol. It is appreciated that once the publishing engine has performed this task for a particular symbol, the publishing engine can use the created image the next time the unrecognized symbol is encountered.

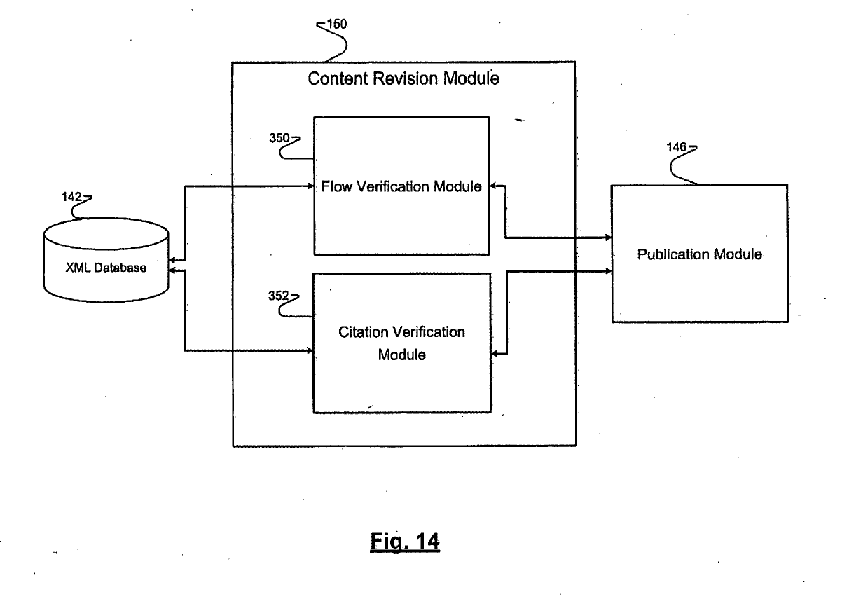

The publishing tool 110 may also include a content revision module 150. The content revision module 150 can be configured to perform analysis of the content to determine if the objects in the content logically flow. Furthermore, the content revision module 150 can be configured to determine whether the user has entered a valid citation. FIG. 14 illustrates exemplary components of the content revision module 150. The content revision module 150 may be comprised of a flow verification module 352 and a citation verification module 354.

The flow verification module 352 receives the XML content and determines whether the references to the objects logically flow. Typically objects in a document, such as tables and images, are assigned sequential identifier numbers throughout the document. Furthermore, the text of the document may have references to the object. For example, a document may contain a “Table 1,” such that throughout the document any reference to the table is made by a reference to “Table 1.” When the XML content is generated, the identifier number of the table is maintained as well as all references thereto. Thus, when the location of an object is rearranged with respect to the other objects in the document, the object is deleted, or new objects are added, the flow verification module 350 extracts the identifier numbers from the content and verifies that the identifier numbers remain sequential. If the objects are no longer sequential, the flow verification module 350 renumbers the identifiers of the objects so that they are sequential. The flow verification module 350 also updates the references to the object in the document so that the references refer to the newly assigned identifier number of the object.

The citation verification module 354 analyzes the citations in a document and substantively verifies the subject matter of the citation. Furthermore, if a citation is incorrect but within a certain tolerance threshold, the citation verification module 354 can insert or recommend a revised citation. As shown in FIG. 9, a citation can be entered by filling predetermined fields. Thus, when the XML content is generated, each component in the citation may be tagged according to the field. Thus, the title of the cited work is tagged, the author's first name and last name are tagged, and any additional data such as volume number, page number, edition number or the like are also tagged. The citation verification module 354 retrieves a citation to a work and queries one or more third party databases, such as the Library of Congress, to determine if the work exists. If the work exists, then the citation is determined to be correct; if not, the citation is incorrect. An incorrect citation may be flagged or corrected.

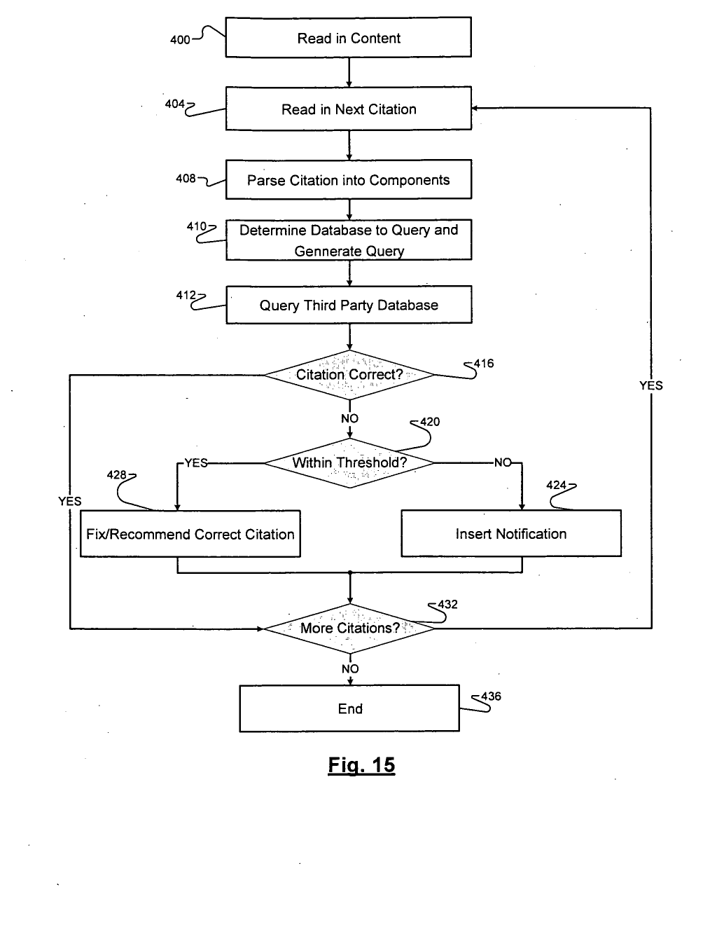

FIG. 15 illustrates an exemplary method that may be executed by the citation verification module 354. The citation verification module 354 first retrieves the content to be examined, as shown at step 400. The content may be retrieved from the XML database 142 or from the publication module 146. The citation verification module 354 then examines the content and finds the first citation in the content, as shown at step 404. The citation verification module 354 can then parse the citation into its components, as shown at step 408. As discussed, the substantive components of the citation will be individually tagged. Thus, the citation verification module 354 examines the tags in the citation and determines the type of citation, e.g. a book citation, an article citation, a treatise citation or the like, and the substantive components, e.g. title, author first name, and author last name. Based on the type of citation, the citation verification module 354 determines the appropriate third party database to query and generates a query, as shown at step 410. For instance, if the citation verification module 354 determines that the citation is to a book, the citation verification module 354 will generate a query for the Library of Congress database or the like. The citation verification module 354 may use the title, the author's last name, and/or the author's first name to generate a query.

The citation verification module 354 then queries the determined third party database or databases via a communications network, as shown at step 412. The results of the query are received from the third party database and then analyzed, as shown at step 416. If no result is returned or a variation of the citation is returned, then the citation is determined to be incorrect. If a positive result is received, thereby indicating that the citation appears correct, the citation verification module 354 determines whether more citations require checking as shown at step 432.

As mentioned, the query may result in a determination that no such work exists or in a determination that a similar citation exists. If no result is received, thereby indicating that the citation is likely incorrect, then a notification of an incorrect citation may be generated. If, however, the query results include a similar citation, then the citation verification module 354 can determine a degree of similarity between the citation being checked and the query results. For instance, a citation may be to a work by John Smith. The query may result in a book having the same title and publisher but with an author name of Jonathan Smith. The citation verification module 354 can then calculate a degree of similarity to the citation being checked. For instance, if the title, publisher, and last name of the author in the citation are correct but the first name is slightly incorrect, then the citation verification module 354 may calculate a percentage of matching text in the citation or a percentage of matching fields. If the degree of similarity is above a predetermined threshold, the citation verification module 354 may attempt to fix the citation or may recommend a corrected citation. For example, if the degree of similarity is above the threshold and only the author's first name is incorrect, the citation verification module 354 may recommend a citation with the correct first name. If the degree of similarity between the citation and the returned result is below a threshold, then a notification of an incorrect citation may be generated and inserted into the content, as shown at step 424. Alternatively, if the citation is incorrect or if no positive result is returned, the citation verification module 354 may generate a notification of an incorrect citation without making a determining of the degree of similarity and without suggesting a corrected citation.

Once a citation is checked, the citation verification module 354 determines if there are any citations to be checked remaining in the content, as shown at step 432. If so, the citation verification module 354 steps back to step 404. If all of the citations have been checked, then the method ends, as shown at 436.

It is envisioned that variations of the foregoing method are contemplated. For instance, the citation verification module 354 may read unparsed text and use pattern matching algorithms to find citations in the text. Once a citation is identified, the citation may be parsed and a query may be generated therefrom. Also, while queries to third party databases are contemplated, the publishing tool may maintain a citation database of works, whereby the citation database is also queried.

It is appreciated that the foregoing method is computer implemented and can be embodied as computer executable instructions stored on a computer readable medium, such that the computer executable instructions are executed by a computer processor.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

A method for publishing a document in a selected format (the publishing may or may not be automatic) may include providing a plurality of presentation features, where a presentation feature defines a manner in which a portion of the document is formatted, receiving a schema for generating markup language content, wherein the schema includes a plurality of elements defined in accordance with a markup language, mapping the plurality of presentation features to the plurality of elements of the schema for the document, wherein a presentation feature of the plurality of presentations features maps to an element of the plurality of elements, generating tags for marking the markup language content based on the mapping of the plurality of presentation features to the plurality of elements, receiving input content from a user via an input module, wherein the input content is formatted by the user using the presentation features, generating markup language content from the input content using the generated tags and the presentation features used to format the input content, wherein the markup language content conforms to the received schema, and/or generating the document in the selected format from the generated markup language content.

The method may further include analyzing at least one of the input content and the markup language content to determine if at least one of the input content and the markup language content conforms to a set of predetermined rules.

The method may further include manipulating the at least one of the input content and the markup language content to conform to the set of predetermined rules when the one of the input content and the markup language content does not conform to the set of predetermined rules.

The method may further include identifying from at least one of the input content and the markup language content a bibliographic citation to an authored work.

The method may further include identifying a plurality of components of the bibliographic citation, including a title of the authored work and/or an author of the authored work.

The method may further include generating a query for a third party database from the identified components and/or querying the third party database to verify accuracy of the bibliographic citation.

The selected format of the method may be an ePub format.

The mapping of the presentation feature to the markup language element in the method may be a one-to-one mapping.

The method may further include mapping a plurality of metadata categories to the plurality of elements, wherein a metadata category of the plurality of metadata categories maps to a metadata element from the plurality of elements.

The method may further include generating metadata tags for the plurality of elements and/or generating markup language content from metadata corresponding to the input content by applying the metadata tags to the metadata corresponding to the input content.

A system for publishing a document in a selected format (the publishing may or may not be automatic) may include a user interface configured to provide a plurality of presentation features to a user, where a presentation feature defines a manner in which a portion of the document is formatted, a schema selection module configured to receive a schema for generating markup language content, wherein the schema includes a plurality of elements defined in accordance with a markup language, a schema mapping module configured to map the plurality of presentation features to the plurality of elements of the schema for the document, wherein a presentation feature of the plurality of presentations features maps to an element of the plurality of elements, a conversion module configured to generate tags for marking the markup language content based on the mapping of the plurality of presentation features to the plurality of elements, a document preparation system configured to receive input content from a user via an input module, wherein the input content is formatted by the user using the presentation features, a content generation module configured to generate markup language content from the input content using the generated tags and the presentation features used to format the input content, wherein the markup language content conforms to the received schema, and/or a publication engine configured to generate the document in the selected format from the generated markup language content.

The system may further include a content revision module configured to analyze at least one of the input content and the markup language content to determine if at least one of the input content and the markup language content conforms to a set of predetermined rules.

The content revision module of the system may be further configured to manipulate the at least one of the input content and the markup language content to conform to the set of predetermined rules when the at least one of the input content and the markup language content does not conform to the set of predetermined rules.

The system may further include a citation verification module configured to identify from at least one of the input content and the markup language content a bibliographic citation to an authored work.

The citation verification module of the system may be further configured to identify a plurality of components of the bibliographic citation, including a title of the authored work and/or an author of the authored work.

The citation verification module of the system may be further configured to generate a query for a third party database from the identified components and/or to query the third party database to verify accuracy of the bibliographic citation.

The selected format of the system may be an ePub format.

The mapping of the presentation feature to the markup language element in the system may be a one-to-one mapping.

The schema mapping module of the system may be further configured to map a plurality of metadata categories to the plurality of elements, wherein a metadata category of the plurality of metadata categories maps to a metadata element from the plurality of elements.

The schema mapping module of the system may be further configured to generate metadata tags for the plurality of elements and/or to generate markup language content from metadata corresponding to the input content by applying the metadata tags to the metadata corresponding to the input content.

A system for verifying a citation may include a document preparation system configured to receive input content from a user and configured to display the received input content to the user, a citation generation module configured to receive a request from the user to insert a bibliographic citation in the input content and configured to insert a plurality of fields corresponding to the bibliographic citation into the input content, wherein each field of the plurality of fields is a different component of the bibliographic citation, and wherein the citation generation module receives information from the user to fill the plurality of fields, and/or a citation verification module configured to generate a query based on the information used to fill the plurality of fields and queries a third party database to determine whether a record exists that corresponds to the information used to fill the plurality of fields.

The information used to fill the plurality of fields in the system may include a title of an authored work and/or an author of the authored work.

The citation verification module of the system may be further configured to receive results from the query and/or to compare the results to the information used to fill the plurality of fields.

The citation verification module of the system may generate a notification of an incorrect citation when the results do not match the information used to fill the plurality of fields.

The citation verification module of the system may be further configured to determine a degree of similarity between the results and the information used to fill the plurality of fields.

The citation verification module of the system may be further configured to revise the bibliographic citation when the degree of similarity between the results and the information used to fill the plurality of fields is greater than a predetermined threshold.

A method for verifying a citation may include receiving input content from a user, wherein the input content is associated with content displayed by a document preparation system, receiving a request from the user to insert a bibliographic citation in the input content, inserting a plurality of fields corresponding to the bibliographic citation into the input content, wherein each field of the plurality of fields is a different component of the bibliographic citation, receiving information from the user to fill the plurality of fields, generating a query based on the information used to fill the plurality of fields, and/or querying a third party database to determine whether a record exists that corresponds to the information used to fill the plurality of fields.

The information used to fill the plurality of fields in the method may include a title of an authored work and/or an author of the authored work.

The method may further include receiving results from the query and comparing the results to the information used to fill the plurality of fields.

The method may further include generating a notification of an incorrect citation when the results do not match the information used to fill the plurality of fields.

The method may further include determining a degree of similarity between the results and the information used to fill the plurality of fields.

The method may further include revising the bibliographic citation when the degree of similarity between the results and the information used to fill the plurality of fields is greater than a predetermined threshold.

A system for managing a project completed on a document preparation system may include an input module configured to receive a request to create a project, identities of a plurality of contributors to the project, a plurality of roles for the plurality of contributors, and/or a timeline indicating an order in which the plurality of contributors contribute to the project, wherein a role indicates a scope of contribution to the project by a particular contributor, a workflow management module configured to create a file corresponding to the project and/or grant permission to the plurality of contributors to access the file, wherein the permission granted to a particular contributor defines an amount of access the particular contributor has to the file and/or the amount of access corresponding to the role of the particular contributor, and/or a document preparation system configured to provide access to the file by the particular contributor in accordance with a scope of the permission granted to the particular contributor and/or according to the timeline.

The roles of the system may include at least one of an author, a copy editor, and a managing editor.

The scope of permission in the system may include generating new content, editing content, and/or reviewing content.

The scope of permission in the system may be defined by a publisher.

The project of the system may be divided into a plurality of parts.

The plurality of roles in the system may further define the parts of the plurality of parts to which the particular contributor can contribute.

A method for managing a project completed on a document preparation system may include receiving a request to create the project, receiving identities of a plurality of contributors to the project, receiving a plurality of roles for the plurality of contributors, wherein a role indicates a scope of contribution to the project by a particular contributor, receiving a timeline indicating an order in which the plurality of contributors contribute to the project, creating a file corresponding to the project, granting permission to the plurality of contributors to access the file on the document preparation system, wherein the permission granted to the particular contributor defines an amount of access the particular contributor has to the file, and wherein the amount of access corresponds to the role of the particular contributor, and/or providing access, via the document preparation system, to the file by the particular contributor in accordance with a scope of the permission granted to the particular contributor and/or according to the timeline.

The roles of the method may include at least one of an author, a copy editor, and a managing editor.

The scope of the permission in the method may include generating new content, editing content, and/or reviewing content.

The scope of the permission in the method may be defined by a publisher.

The project of the method may be divided into a plurality of parts.

The plurality of roles in the method may further define the parts of the plurality of parts to which the particular contributor can contribute.

As used herein, the terms module, engine and processor may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

While example embodiments have been particularly shown and described, it will be understood by those of ordinary skill in the art that various changes in form and details may be made therein without departing from the spirit and scope of the present invention as defined by the following claims.

What is claimed is:

1. A method for publishing a document in a selected format, the method comprising:
providing a plurality of presentation features, where a presentation feature defines a manner in which a portion of the document is formatted;
receiving a schema for generating markup language content, wherein the schema includes a plurality of elements defined in accordance with a markup language;
mapping the plurality of presentation features to the plurality of elements of the schema for the document, wherein a presentation feature of the plurality of presentations features maps to an element of the plurality of elements;
generating tags for marking the markup language content based on the mapping of the plurality of presentation features to the plurality of elements;
receiving input content from a user via an input module, wherein the input content is formatted by the user using the presentation features;
generating markup language content from the input content using the generated tags and the presentation features used to format the input content, wherein the markup language content conforms to the received schema; and
generating the document in the selected format from the generated markup language content.

2. A system for publishing a document in a selected format, the system comprising:
a user interface configured to provide a plurality of presentation features to a user, where a presentation feature defines a manner in which a portion of the document is formatted;
a schema selection module configured to receive a schema for generating markup language content, wherein the schema includes a plurality of elements defined in accordance with a markup language;
a schema mapping module configured to map the plurality of presentation features to the plurality of elements of the schema for the document, wherein a presentation feature of the plurality of presentations features maps to an element of the plurality of elements;
a conversion module configured to generate tags for marking the markup language content based on the mapping of the plurality of presentation features to the plurality of elements;
a document preparation system configured to receive input content from a user via an input module, wherein the input content is formatted by the user using the presentation features;
a content generation module configured to generate markup language content from the input content using the generated tags and the presentation features used to format the input content, wherein the markup language content conforms to the received schema; and
a publication engine configured to generate the document in the selected format from the generated markup language content.

3. The system of claim 2 further comprising a content revision module configured to analyze at least one of the input content and the markup language content to determine if at least one of the input content and the markup language content conforms to a set of predetermined rules.

4. The system of claim 3 wherein the content revision module is further configured to manipulate the at least one of the input content and the markup language content to conform to the set of predetermined rules when the at least one of the input content and the markup language content does not conform to the set of predetermined rules.

5. The system of claim 2 further comprising a citation verification module configured to identify from at least one of the input content and the markup language content a bibliographic citation to an authored work.

6. The system of claim 5 wherein the citation verification module is further configured to identify a plurality of components of the bibliographic citation, including a title of the authored work and an author of the authored work.

7. The system of claim 6 wherein the citation verification module is further configured to generate a query for a third party database from the identified components and to query the third party database to verify accuracy of the bibliographic citation.

8. The system of claim 2 wherein the selected format is an ePub format.

9. The system of claim 2 wherein the mapping of the presentation feature to the markup language element is a one-to-one mapping.

10. The system of claim 2 wherein the schema mapping module is further configured to map a plurality of metadata categories to the plurality of elements, wherein a metadata category of the plurality of metadata categories maps to a metadata element from the plurality of elements.

11. The system of claim 10 wherein the schema mapping module is further configured to generate metadata tags for the plurality of elements and to generate markup language content from metadata corresponding to the input content by applying the metadata tags to the metadata corresponding to the input content.

12. A system for verifying a citation, the system comprising:
a document preparation system configured to receive input content from a user and configured to display the received input content to the user;
a citation generation module configured to receive a request from the user to insert a bibliographic citation in the input content and configured to insert a plurality of fields corresponding to the bibliographic citation into the input content, wherein each field of the plurality of fields is a different component of the bibliographic citation, and wherein the citation generation module receives information from the user to fill the plurality of fields; and
a citation verification, module configured to generate a query based on the information used to fill the plurality of fields and queries a third party database to determine whether a record exists that corresponds to the information used to fill the plurality of fields.

13. The system for verifying a citation of claim 12 wherein the information used to fill the plurality of fields includes a title of an authored work and an author of the authored work.

14. The system for verifying a citation of claim 12 wherein the citation verification module is further configured to receive results from the query and to compare the results to the information used to fill the plurality of fields.

15. The system for verifying a citation of claim 14 wherein the citation verification module generates a notification of an incorrect citation when the results do not match the information used to fill the plurality of fields.

16. The system for verifying a citation of claim 14 wherein the citation verification module is further configured to determine a degree of similarity between the results and the information used to fill the plurality of fields.

17. The system for verifying a citation of claim 16 wherein the citation verification module is further configured to revise the bibliographic citation when the degree of similarity between the results and the information used to fill the plurality of fields is greater than a predetermined threshold.

18. A method for verifying a citation, the method comprising:
receiving input content from a user, wherein the input content is associated with content displayed by a document preparation system;
receiving a request from the user to insert a bibliographic citation in the input content;
inserting a plurality of fields corresponding to the bibliographic citation into the input content, wherein each field of the plurality of fields is a different component of the bibliographic citation;
receiving information from the user to fill the plurality of fields;
generating a query based on the information used to fill the plurality of fields; and
querying a third party database to determine whether a record exists that corresponds to the information used to fill the plurality of fields.

19. A system for managing a project completed on a document preparation system, the system comprising:
an input module configured to receive
a request to create a project,
identities of a plurality of contributors to the project,
a plurality of roles for the plurality of contributors, and
a timeline indicating an order in which the plurality of contributors contribute to the project,
wherein a role indicates a scope of contribution to the project by a particular contributor;
a workflow management module configured to
create a file corresponding to the project, and
grant permission to the plurality of contributors to access the file,
wherein the permission granted to a particular contributor defines an amount of access the particular contributor has to the file, and the amount of access corresponding to the role of the particular contributor; and
a document preparation system configured to provide access to the file by the particular contributor in accordance with a scope of the permission granted to the particular contributor and according to the timeline.

20. The system of claim 19 wherein the roles include at least one of an author, a copy editor and a managing editor.

21. The system of claim 19 wherein the scope of permission includes generating new content, editing content, and reviewing content.

22. The system of claim 19 wherein the scope of permission is defined by a publisher.

23. The system of claim 19 wherein the project is divided into a plurality of parts.

24. The system of claim 23 wherein the plurality of roles further defines the parts of the plurality of parts to which the particular contributor can contribute.

25. A method for managing a project completed on a document preparation system, the method comprising:
receiving a request to create the project;
receiving identities of a plurality of contributors to the project;
receiving a plurality of roles for the plurality of contributors, wherein a role indicates a scope of contribution to the project by a particular contributor;
receiving a timeline indicating an order in which the plurality of contributors contribute to the project;
creating a file corresponding to the project;
granting permission to the plurality of contributors to access the file on the document preparation system, wherein the permission granted to the particular contributor defines an amount of access the particular contributor has to the file, and wherein the amount of access corresponds to the role of the particular contributor; and
providing access, via the document preparation system, to the file by the particular contributor in accordance with a scope of the permission granted to the particular contributor and according to the timeline.
